(19) United States
(12) Patent Application Publication
(10) Pub. No.: US 2004/0249013 A1
(43) Pub. Date: Dec. 9, 2004

(54) Method for treating a porous material

(76) Inventor: Bernard Tilquin, Mont-Saint-Guilbert (BE)

Correspondence Address: William M Lee Jr, Barnes & Thornburg, P O Box 2786, Chicago, IL, 60690-2786, US

(21) Appl. No.: 10/477,563

(22) PCT Filed: May 10, 2002
(86) PCT No.: PCT/EP02/05237

(30) Foreign Application Priority Data
May 10, 2001 (EP) 01111417.0

(51) Int. Cl. C08J 3/28; C08F 2/46; C08J 9/00

(52) U.S. Cl. 522/113; 521/50.5; 521/54; 527/100

(57) ABSTRACT

The invention concerns a method for treating a porous material based on cellulose and/or lignin which consists in impregnating said porous material with at least a monomer comprising at least an irradiation-polymerisable vinyl group, then in irradiating the impregnated material with high-energy ionising radiation. The impregnating monomer comprises a grafting monomer having at least a function capable of reacting with the hydroxyl groups of the cellulose and/or the lignin and/or at least a cross-linking monomer, and the impregnation is carried out under conditions suitable for limiting the thickness of the impregnation layer to a thickness of 0.1 to 5 mm beneath the surface of the porous material. The invention is applicable to a material whereof the moisture impermeability coefficient does not exceed 55.

The present invention relates to a method for treating a porous material based on cellulose and/or lignin as well as to a material having a reduced moisture impermeability coefficient. More particularly, the present invention relates to a method for impregnating a natural material such as wood which allows to considerably and durably reduce the moisture impermeability of the so treated material with respect to the treatment methods already known.

### TECHNICAL BACKGROUND

Among the methods of treatment of porous materials based on cellulose and/or lignin, there is already known the “plastic wood” (U.S. Pat. Nos. 3,077,417 to 3,077,420) obtained by degassing wood under vacuum, then impregnating the wood under pressure with methyl methacrylate until saturation, bringing impregnated wood under nitrogen, then irradiation by a source of cobalt-60 or césium-137 at a dose below 4 Mrads in order to polymerize the methyl methacrylate. This process is slow, leads to a heavy product having a water retention (about 30% by weight) which is too high. Moreover, certain substances contained in wood, for example quercetine, may inhibit polymerization. Finally, methyl methacrylate impregnation does not allow obtaining a true dimensional stability of the treated material. Alternatively, the use of an electron beam at a dose of 10 à 15 Mrads results only in a very partial (30 to 50%) hardening of the monomer. British patent 845.690 describes a kinetic improvement of this process consisting in mixing, before irradiation, the cellulose substrate with a water-soluble non polymerizable swelling agent and then eliminating this swelling agent after irradiation. The goal is to improve the grafting efficiciency, defined by the fact the polymer formed is chemically bound to cellulose, and is located in the interstices as well as at the cellulose surface. Examples X and XI of this British patent 845.690 describe the irradiation, through a Van de Graaff accelerator under an electron beam having an energy of 2 Mev (i.e. a dose of 1.5 Mrad), of a regenerated cellulose film placed in a cell filled with glycidyl methacrylate. Here too, impregnation is thus carried out until saturation of the cellulose substrate by the monomer.

Patent application EP-A-990.493 describes a process for the preparation of wood-plastic material combinations by which wood is brought into contact with an impregnation mixture containing polymerizable components for the impregnation of at least part of the wood, according to which wood is saturated with the impregnation mixture and then polymerization (hardening) of the impregnation mixture is executed in the presence of free radical initiators and/or antioxidants by irradiation with a high energy electron beams accelerator with electron beams whose energy ranges from 0.2 MeV to 15 MeV, characterised in that the irradiated wood is then stored during 5 hours up to 10 days at a temperature ranging between 20° C. and 100° C. The impregnation mixture may in particular comprise glycidyl methacrylate or a polyfonctional (meth)acrylate such as the di(meth)acrylates of ethylene glycol, of diethylene glycol, of triethylene glycol or of tetraethylene glycol, bisphenol-A dimethacrylate, pentaerythritol tetra(meth)acrylate and trimethylolpropane tri(meth)acrylate. The examples of this document illustrate wood saturation by an embodiment consisting in placing wood in an impregnation bowl under vacuum and pressure, establishing a vacuum of 60 mbar during half an hour, immersing the wood under vacuum in the impregnation mixture, then establishing a nitrogen pressure of 5 bars during one hour before irradiation. Here too, impregnation is thus carried out until saturation of the wood by the monomer. It results, as in the patents first cited above, in a process comprising a lot of steps, long and complicated, and as a consequence not very economical. In addition, the impregnation process until saturation implies the use of large quantities of monomers (therefore a significant increase of the weight of the wood per volume unit) and, during the hot storing step of patent application EP-A-990.493, the evaporation in ambient air of fragrant and potentially toxic monomers, i.e. ecologic nuisances.

Patent application EP-A-1.057.840 describes, for treating a cellulose substrate while improving its heat resistance, the use of an agent which may be cross-linked by an electron beam comprising at least 5% by weight of a component polymerisable at a high boiling point (at least 120° C.) having the formula (I) CH═C(CHR₅OR₆)COOR₁, wherein each R₁ and R₅ is hydrogen or an alkyl group, that is (according to the meaning of R₆) an acrylic acid or an α-hydroxyalkyle acrylate or an α-polyethyleneoxyalkyl acrylate. In this electron beam cross-linkable agent, component (I) is mixed with 5 to 50% by weight of another component polymerisable at a high boiling point and selected from polyepoxydated compound (meth)acrylates having a molecular weight of at least 900 and cross-linkable polymers having a molecular weight above 1000 and being obtainable by polymerising a methacrylate ester containing an epoxy group (such as glycidyl methacrylate). It is clear, depending from the meaning of R₆, that neither component (I) nor the other polymerisable component may be qualified as grafting or cross-linking monomers. Moreover, although this document specifies that the acceleration voltage should be at most equal to 500 kV to be efficient, it does not contain details relating to the method for implementing these components.

Another treatment process, called “sticked plastic”, consists in coating the wood with a primary layer, then with a secondary layer (based on solvents) in order to fill in the holes and finally with a finishing layer based on acrylic monomers polymerisable with ultraviolet radiation. The main disadvantage of the process consists in the rapid delamination of the coating, thus requiring a frequent repetition of the treatment. Since polymerisation occurs only at the surface, there cannot be a grafting onto the wood components. An alternative to this type of process consists in coating the wood with a polyurethane which forms a plastic film not being grafted onto wood and, for this reason, easily delaminating and therefore having the disadvantage of needing a frequent application onto the wood in order to preserve protection against moisture.

In various areas of the world, various wood species remain highly appreciated and used for the construction of buildings or parts of buildings exposed to ambient atmosphere moisture, to precipitation and/or climatic variations of all kinds, namely to the effects of sun radiation. A lasting protection against these natural building-wood deterioration factors therefore constitutes a first scale economic goal. In particular, the cost of maintenance and/or restoration of natural wood is mainly constituted of manpower costs, and it is therefore important that maintenance may be spaced in time with comparable efficiency. Hence, there is a need for a process of treatment of wood or analogue porous materials, the efficiency of which lasts a sufficiently long time, so that treatment needs to be repeated only at highly spaced intervals, preferably one or more decades. There is a also a need for a process of treatment of wood or analogue porous materials using smaller amounts of costly, volatile, odorous and/or potentially toxic monomers, that is an ecologic and more environment friendly process. There is a also a need for a process of treatment of wood or analogue porous materials requiring only a limited number of steps, preferably not requiring the time and post-treatment constraints of the prior art (for instance the hot storing step provided in patent application EP-A-990.493). There is a also a need for the moisture resistance of natural wood to be improved without significantly increasing the weight of the material per volume unit, i.e. without making the structure of buildings using wood heavier. It is also desirable that the thus treated wood be furthermore protected against the most various biologic degradation factors such as various species of insects and mushrooms. Other needs to be met simultaneously in this technical field are, on the one hand, the absence of oily or sticky aspect of wood upon touching after treatment and, on the other hand, the absence of lasting modification of the mechanical properties and of the dimensional stability of the wood after treatment.

### SUMMARY OF THE INVENTION

The present invention is based on the unexpected finding that a piece of porous material based on cellulose and/or lignin, such as wood, may be treated against moisture and other various natural or biologic degradation factors in both an improved and lasting manner by impregnation of said porous material by at least a vinylic monomer polymerisable by radiation, then irradiation of the impregnated porous material by a high energy ionising radiation, provided that impregnation is carried out under conditions suitable for implementing a partial and superficial impregnation of the porous material, i.e. suitable for limiting the impregnation of the monomer to a superficial layer, the thickness of which is substantially lower than the thickness of the piece of material to be treated, and provided that the amount of the impregnation of the monomer(s) is also limited, preferably between about 1 and 9% by weight with respect to the porous material layer concerned by said impregnation.

The present invention is also based on the unexpected finding that an ecological, improved and lasting treatment of wood against moisture and other natural or biologic degradation factors may be obtained by a process with a fast and economic implementation, comprising few steps and wherein the impregnation step by one or more vinylic monomers polymerisable by radiation is executed under a pressure which does not substantially differ from atmospheric pressure.

Hens, it is possible, according to another aspect of the present invention, to obtain a porous material based on cellulose and/or lignin such as wood comprising, on a thickness of about 0.1 to 5 mm under its surface, a moisture impermeable film comprising a polymer grafted onto said porous material and/or cross-linked such that the moisture impermeability coefficient of said material does not exceed about 55, said coefficient being defined as the product of the weight rate (expressed as a percentage) of moisture take-up of the treated material, after being dipped into water at 20° C. during 48 hours, by the weight rate (expressed as a percentage), with respect to the porous material, of the monomer(s) constituting the polymer of said moisture impermeable film. A value of 55 for this coefficient clearly means, as an example, that a moisture take-up rate of the wood of 11% by weight (measured under the above conditions) is obtained by the presence of at most 5% by weight of monomer(s) with respect to the polymer film grafted onto the porous material and/or cross-linked. Such a porous material protected against moisture and other natural or biologic degradation factors may advantageously be obtained by superficial impregnation of by one or more monomers polymerisable by radiation under conditions detailed hereinafter.

Thus the method constituting the first aspect of the invention warrants a controlled moisture take-up of the treated porous material while using a minimal amount of the impregnation monomer and without the need to use non polymerisable environmentally harmful organic solvents, or a costly device for impregnation under vacuum and pressure as in the so-called “plastic wood” technology.

### DETAILED DESCRIPTION OF THE INVENTION

In accordance with a first aspect, the present invention relates to a method for treating a piece of porous material based on cellulose and/or lignin comprising:

(a) impregnating the piece of porous material with at least one impregnation monomer comprising at least a vinyl group polymerisable by radiation, said impregnating monomer preferably comprising a grafting monomer having at least one function or a chemical group capable of reacting with the hydroxyl groups of the cellulose and/or of or the lignin and/or a cross-linking monomer, then

(b) irradiating with high-energy ionising radiation the piece of porous material impregnated in accordance with step (a),

said method being characterised in that the impregnation is executed under conditions suitable for limiting, preferably while limiting, the thickness of the impregnation layer to a thickness of about 0.1 to 5 mm beneath the surface of the piece of porous material and in that the amount of the impregnating monomer is comprised between about 1 and 9% by weight of the layer of porous material dealt with by the impregnation.

Preferably, the impregnation step of the method according to the invention is carried out under a pressure which does not substantially depart from atmospheric pressure, i.e. does not depart from the latter by more than about 10% more or less. Preferably, the pressure is therefore substantially constant over the whole duration of the impregnation process. Thus, the method according to the invention does not require a vacuum device or a pressure device or a device for measuring or controlling pressure during the impregnation step, resulting in a large simplification of the method of treating a porous material against moisture and other natural or biologic degradation factors without being detrimental, on the contrary, to the efficiency of said treatment.

The method according to the invention is particularly well suited for the treatment of pieces of porous material, each dimension of which is at least equal to about 10 mm, whatever the geometrical shape of the piece to be treated is. Because of the characteristics of the high energy ionising radiation used during step (b) of the method and because of the superficial and partial character of the monomer impregnation, the size (from a few centimetres to a few metres) and the shape (convex, concave, linear, curved, spherical or other) of the piece of porous material to be treated may be absolutely any one.

Preferably, the method according to the invention is carried out while limiting the monomer impregnation, beneath the surface of the piece of porous material, to a layer the thickness of which does not exceed about 30%, preferably about 20% and more particularly about 10% of the smallest dimension of said piece.

According to the invention, an impregnation system is used which comprises one or more grafting monomers and/or one or more cross-linking monomers, provided that their impregnation into the porous material be controlled and limited to a thickness typically from about 0.1 to 5 mm, substantially lower than that of the piece of material to be treated and located immediately beneath the surface thereof in contact with external atmosphere. Any vinyl monomer polymerisable by radiation, having at least one function capable of reacting with the hydroxyl groups of the cellulose and/or the lignin, i.e. able to graft through covalent bonds with the porous material, is susceptible of being used in the method according the invention. Without constituting a limitation of the present invention, a particularly efficient chemical function in this respect is the epoxy function. Moreover, a vinyl function having a particularly advantageous irradiation polymerisation speed is the acrylic function (this term also includes the methacrylic function). As a consequence, a grafting monomer particularly advantageous for impregnation in step (a) of the method according to the invention is a monomer having both an acrylic function and an epoxy function such as an epoxy-acrylate. In this type of monomer, it is preferred that the acrylic and epoxy functions be sufficiently spaced from each other, such as for example in an epoxyalkyl acrylate or methacrylate the alkyl group of which has from 4 to 20 carbon atoms. It may also be envisaged to use glycidyl acrylate or methacrylate. It is also preferred that the epoxy function is located at one chain end of the molecule, for a better reactivity with the hydroxyl groups of the cellulose and/or the lignine. It is also preferred that the molecular weight of the epoxy-acrylate does not exceed about 400. Examples of usable epoxydated monomers therefore comprise the acrylates and methacrylates of epoxybutyl, epoxyhexyl, epoxyoctyl, epoxynonyl, epoxydecyl, epoxydodecyl, epoxyoctadecyl, etc. Other grafting monomers usable within the scope of the present invention may also be derived from an epoxy-acrylate by opening of an epoxy function and subsequent formation of a hydroxy function. Other useful grafting monomers may comprise several acrylic functions and several epoxy functions or epoxy-derived functions, however, their complexity and additional cost are not compensated by specific advantages vis-à-vis the commercially available, previously cited monomers.

The cross-linking monomers suitable for carrying out the method according to the invention are well known by those skilled in the art. A vinyl function having a particularly advantageous irradiation polymerisation speed being an acrylic function or the like, a cross-linking monomer particularly advantageous for impregnation in step (a) of the method according to the present invention is a polyfunctional derivative of an α,β-ethylenically unsatured acid such as acrylic acid, methacrylic acid, crotonic acid, itaconic acid, maleic acid, fumaric acid, etc. In a particularly preferred manner, said polyfunctional derivative may be a di-, tri- or tetra-polyol acrylate or methacrylate. As non limitative examples of such cross-linking monomers the diacrylates and dimethacrylates of propanediol, butanediol, hexanediol, octanediol, nonanediol, decanediol and eicosanediol, the diacrylates and dimethacrylates of ethylene glycol, diethylene glycol, triethylene glycol, tetraethylene glycol, polyethylene glycol and neopentyl glycol, the triacrylates and trimethacrylates of trimethylolpropane and pentaerythritol, the tetraacrylate and tetramethacrylate of pentaerythritol, the diacrylates and dimethacrylates of bisphenol A and ethoxylated bisphenol A, and the mixtures of these monomers in all proportions can be cited.

The grafting monomer(s) and/or the crosslinking monomer(s) may optionally mixed with another monomer having no grafting or crosslinking capacity, provided that the nature and proportion of this other monomer in said mixture does not alter its capacity for a partial and superficial impregnation of the porous material to be treated. Preferably, this other monomer is perfectly miscible with the grafting and/or the crosslinking monomer(s) and, like them, is easily radiation polymerisable by a high energy ionising radiation. As an example of such other monomer one can cite a mono-acrylate or methacrylate being not or little reactive with the hydroxyl function, provided that the mixture of these monomers be in proportions such that the viscosity of the mixture at 25° C. be preferably comprised between about 10 and 3000 mPa.s and that the grafting and/or radiation crosslinking capacity is not affected by the presence of this other monomer. As a general rule such other monomer, for instance an alkyl (meth)acrylate (such as the acrylates and methacrylates of methyl, ethyl, isopropyl, butyl, pentyl, n-hexyl, n-octyl, n-decyl, tetradecyl, etc.), will be used in a proportion which does not exceed about 30% by weight of the impregnation mixture, the proportion of the grafting and/or the crosslinking monomer(s) in this mixture thus being at least about 70% by weight.

Several, in fact mainly four, method parameters allow to define suitable impregnation conditions, alone or in combination, for limiting the thickness of the impregnation layer to a thickness, typically from about 0.1 to 5 mm, substantially lower than that of the material to be treated and located immediately beneath the surface thereof in contact with external atmosphere. These parameters include:

an impregnation temperature comprised between about 10° C. and 80° C., preferably between about 20° C. and 50° C.,

an impregnation duration not exceeding about 90 minutes,

a moisture ratio of the material to be treated not exceeding about 12% by weight, but preferably not lower than about 5% by weight (such a residual moisture having a favourable effect on the implementation of the method), and

a viscosity at 25° C. of the impregnation system comprising the grafting monomer and/or the cross-linking monomer (and, optionally, the other non reactive monomer) comprised between about 10 and 3000 mPa.s.

From these general indications, the skilled person is able to determine by routine experimentation on the one hand the monomers or mixtures of monomers meeting the preferential viscosity condition and on the other hand, as a function of the retained impregnation system and its viscosity, the suitable combination of other conditions (temperature and duration) of impregnation. For example, the impregnation temperature will be selected all the higher since the duration will be shorter and/or the viscosity at 25° C. will be higher. With respect to the moisture requirement of the porous material, it means that the efficiency of the method according to the invention cannot be fully guaranteed when the moisture ratio of the porous material to be treated exceeds about 12% by weight and, as a consequence, that it is desirable to submit the latter to a preliminary drying step in order to decrease its moisture ratio at least until this value before starting the treatment according to the invention. At the opposite, this preliminary drying step should not, for an optimal efficiency of the method according to the invention, dry the porous material until a residual moisture ratio below about 5% by weight since, without wishing to be bound by this theory, water included in the material to be treated seems to play a favourable role in the properties of the material after treatment. The amount of grafting monomer and/or cross-linking monomer used for impregnation largely depends from the four previously cited method requirements. For a satisfactory and lasting protection of the porous material against moisture and other natural or biologic degradation factors, it is usually sufficient that this amount be comprised between about 1 and 9%, preferably between about 2 and 6%, of the weight of that part of the porous material dealt with by impregnation. The skilled person will therefore always be able, starting from the above indications and as a function of the economic conditions that will be imposed on him, such as the cost of the grafting monomer and/or cross-linking monomer, to select the method conditions suited for achieving the goal set.

The method of treatment according to the invention is applicable to any porous material based on cellulose and/or lignin, such as namely a natural or reconstituted wood, belonging to various species of broad-leaved trees or conifers such as for example Scots pine (pinus sylvestris), poplar tree (populus sp), silver birch (betula sp), spruce (picea abies), beech tree (fagus sylvatica), douglas (pseudotsuga douglasii) and the like. As is easily conceivable with respect to natural materials, the amount of grafting monomer and/or cross-linking monomer used for impregnation may vary from one species to another, while being comprised within the range previously indicated. The shape of the piece of porous material to be treated does not constitute a critical parameter of the present invention and may be of any kind, provided only that it allows a sufficiently uniform impregnation and irradiation. With respect to pieces intended for the construction of buildings, they may be boards, beams, blocks and the like. With respect to pieces intended for decoration, they may be benches, mouldings, pilasters and the like, in particular thoses intended to be exposed outside. In order for the method of treatment according to the invention to consist in a superficial impregnation of the piece of porous material, it is obviously desirable that each dimension of said piece be at least equal to about 10 mm.

The method of treatment according to the invention may use any high energy ionising radiation able to polymerise the impregnating vinyl monomer, such as gamma irradiation (for example by a source of cobalt-60) and accelerated electron beam or heavy ion beam. Preferably, the energy used in the irradiation step is comprised between about 1 MeV and 10 MeV. An energy below about 1 MeV is not very efficient, whereas an energy above about 10 MeV entails an induced radioactivity. However, in order for the polymerisation kinetics to be sufficiently quick and, consequently, the method to be sufficiently efficient, it is desirable that the irradiation energy used be at least equal to about 20 KGy. Under industrial conditions, the irradiation energy may easily reach about 100 KGy. The irradiation duration ranges typically from 1 to a few seconds. Equipment able to provide such a high energy ionising radiation is well known in the state of the art and include for example rhodotrons.

It may be advantageous, in order to further decrease the moisture take-up weight ratio (expressed as a percentage) of the material, to repeat at least once the treatment according to the invention on the material already impregnated and irradiated once. The impregnation and irradiation conditions during this subsequent treatment may be identical to or different from the conditions prevailing during the first treatment, while preferably staying within the previously indicated ranges of parameters. As may easily be understood, this subsequent impregnation results in increasing the weight ratio (expressed as a percentage) of the monomer(s) with respect to the porous material, even if the amount of impregnated monomer(s) during this subsequent treatment is generally much lower (of the order of one tenth up to one half) than that implemented during the first treatment. For this reason, while decreasing the moisture take-up weight ratio (expressed as a percentage) of the material, the subsequent treatment does not necessarily result in decreasing the impermeability coefficient (MIC) of the treated material.

According to a second aspect, the present invention relates to a porous material based on cellulose and/or lignin, such as wood, comprising, along a thickness of about 0.1 to 5 mm under its surface, a moisture impermeable film comprising a polymer grafted to said porous and/or cross-linked material such that the moisture impermeability coefficient (hereinafter MIC, by abbreviation) of the material does not exceed about 55, said coefficient being defined as the product of the weight ratio (expressed as a percentage) of moisture take-up of the treated material, after having been dipped into water at 20° C. for 48 hours, with the weight ratio (expressed as a percentage), relatively to the porous material (the part of porous material comprising the impermeable film), of the monomer(s) constituting the polymer of the said moisture impermeable film.

The method for treating a porous material according to the invention easily allows to yield very low MIC coefficients, i.e. (as it is demonstrated hereinafter in some implementing examples of the invention) MIC coefficients of the order of about 25 for a wood from the species Pinus sylvestris and of the order of about 28 for a wood from the species Populus sp. At a constant MIC coefficient, it is obviously desirable that moisture take-up weight ratio of the material, after having been dipped into water at 20° C. for 48 hours, be as low as possible, without however requiring monomer amounts which would render the method economically not interesting. In practice, it proves to be possible that the weight ratio of moisture take-up of the treated material, after having been dipped into water at 20° C. for 48 hours, does not exceed about 14% when the porous material is a wood of the species Pinus sylvestris, and respectively about 18% when the porous material is a wood of the species Populus sp. As it is demonstrated hereinafter in some implementing examples of the invention, the weight ratio of moisture take-up of a wood of the species Pinus sylvestris, after having been dipped into water at 20° C. for 48 hours, may currently reach about 10% after a single impregnation and about 9% after a double impregnation. Similarly, the weight ratio of moisture take-up of a wood of the species Populus sp, after having been dipped into water at 20° C. for 48 hours, may currently reach about 11% after a single impregnation and about 8% after a double impregnation.

The method of treatment and the treated porous material according to the invention offer a lot of advantages:

the moisture resistance of the porous material (for example natural wood from various species) is considerably and lastingly improved without significantly increasing the material weight per volume unit, i.e. without making structures heavier (for instance those of buildings) using the material treated this way.

the material is furthermore protected, for a long time, against a large diversity of biologic degradation factors such as various species of insects and mushrooms.

the material, after treatment, has no oily or sticky aspect upon touching which would be unpleasant for handling or transport by users,

a lasting modification of the mechanical properties and/or the dimensional stability of the material after treatment has not been found.

no peeling-off phenomenon of the polymer film, as in the case of the same material being treated with a polyurethane coating (the so-called “sticked plastic” technique described above in the paragraph related to the state of the art), has been noticed because of the chemical bond between the latter and the hydroxyl groups of the porous material.

using a device for impregnating under vacuum and pressure is no longer necessary.

The following examples are provided as a pure illustration of the present invention and, do in no way limit the scope thereof.

### EXAMPLES 1 to 33

### Impregnation of Pinus sylvestris

Samples of benches made from Scots pine (Pinus sylvestris) with dimensions 70×40×20 mm are used. After drying freely in air, the samples are placed in a climatised room maintained at a temperature of 20° C. and at a relative moisture ratio of 50% until stabilisation of their weight. After two weeks under these conditions of preparation, the equilibrium moisture ratio of the wood was about 10%. In order to conduct the experiment under conditions as close as possible to the usual conditions of implementation and working of wood in a structure, and in order to avoid that the entry of the impregnation product through the transverse face of the sample may interfere, this transverse face was previously water-proofed in a known manner by applying several layers of a polyurethane varnish. The weight of the sample thus prepared is written down.

In order to visually observe the distribution of the impregnating monomer (or, if need be, of the mixture of monomers) within the wood, a few milligrams of a blue “astra” dye were solubilised in each monomer. Directly at the outlet of the climatised room, the sample is impregnated during sixty minutes, under shelter from ultraviolet radiation, with the selected monomer (or the carefully homogenised mixture of monomers) maintained at the temperature of 22° C. In accordance with the monomer viscosity at the selected temperature, a superficial impregnation on a thickness of the order of 0.4 to 2 mm is thus obtained. Through a new measurement of the sample weight, the weight ratio (expressed as a percentage) of the impregnated monomer(s) with respect to the wood is determined and written as t₁ in table 1 hereinafter. Thereafter, the polymerisation of the monomer (or of the mixture of monomers) is performed by exposure to gamma radiation (cobalt 60) in such a manner as to receive a dose of 50 KGy. The temperature increase of the sample during irradiation does not exceed 5° C.

After irradiation, the sample is submitted to a test consisting in dipping it in water at 20° C. during 48 hours, then measuring again its weight so as to calculate the weight ratio (expressed as a percentage) of moisture take-up of the wood. This ratio is written as t₂ in table 1 hereinafter. Finally, the moisture impermeability coefficient is calculated with the formula:

MIC=t₁×t₂

and reported in table 1 hereinafter.

The monomer used in example 1 is an epoxydated monoacrylate. In examples 2 to 5 mixtures comprising ⅔ (by weight) of a monoacrylate commercialised under the trade name Ebecryl 111 and ⅓ (by weight) of a polyfunctional acrylate defined hereinafter are used. In examples 6 to 9 mixtures comprising ⅓ (by weight) of the monomer Ebecryl 111 and ⅔ (by weight) of a polyfunctional acrylate defined hereinafter are used. In examples 10 to 13 mixtures comprising ⅔ (by weight) of a monoacrylate commercialised under the trade name Ebecryl 112 and ⅓ (by weight) of a polyfunctional acrylate defined hereinafter are used. In examples 14 to 17 mixtures comprising ⅓ (by weight) of the monomer Ebecryl 112 and ⅔ (by weight) of a polyfunctional acrylate defined hereinafter are used. In examples 18 to 25 mixtures comprising ⅔ (by weight) of the monomer of example 1 and ⅓ (by weight) of an acrylate defined hereinafter are used. In examples 26 to 33 mixtures comprising ⅓ (by weight) of the monomer of example 1 and ⅔ (by weight) of an acrylate defined hereinafter are used.

The polyfonctional acrylate used in examples 2, 6, 10, 14, 19 and 27 is a tetrafonctional acrylate commercialised under the trade name Ebecryl 80.

The polyfonctional acrylate used in examples 4, 8, 12, 16, 23 and 31 is a tetrafonctional acrylate commercialised under the trade name Ebecryl 40.

The acrylate used in examples 3, 7, 11, 15, 22 and 30 is an ethoxylated trimethylolpropane triacrylate commercialised under the trade name Ebecryl 160.

The polyfonctional acrylate used in examples 5, 9, 13, 17, 24 and 32 is trimethylolpropane triacrylate.

The acrylate used in examples 20 and 28 is the monomer Ebecryl 111. The acrylate used in examples 21 and 29 is the monomer Ebecryl 112.

The polyfonctional acrylate used in examples 18 and 26 is tripropylene glycol diacrylate. The polyfonctional acrylate used in examples 25 and 33 is dipropylene glycol diacrylate.

All monomers under the trade name Ebecryl are commercially available from the company UCB (Drogenbos, Belgium).

TABLE I

| Example | t₁ | t₂ | MIC |
|---|---|---|---|
| 1 | 2.5 | 11.9 | 29.9 |
| 2 | 2.3 | 12.4 | 28.5 |
| 3 | 2.1 | 12.8 | 26.8 |
| 4 | 1.8 | 12.3 | 22.6 |
| 5 | 3.8 | 11.9 | 45.2 |
| 6 | 2.7 | 11.6 | 31.1 |
| 7 | 2.3 | 11.3 | 26.2 |
| 8 | 4.0 | 11.3 | 45.2 |
| 9 | 2.6 | 11.2 | 29.0 |
| 10 | 2.1 | 11.2 | 23.1 |
| 11 | 2.5 | 11.5 | 29.1 |
| 12 | 3.3 | 11.3 | 37.9 |
| 13 | 3.1 | 12.0 | 37.0 |
| 14 | 3.0 | 10.4 | 31.4 |
| 15 | 2.6 | 11.5 | 29.8 |
| 16 | 2.7 | 11.5 | 31.3 |
| 17 | 2.9 | 12.6 | 36.8 |
| 18 | 3.5 | 12.8 | 44.8 |
| 19 | 3.3 | 12.2 | 40.3 |
| 20 | 2.4 | 10.7 | 25.7 |
| 21 | 2.7 | 11.5 | 31.0 |
| 22 | 3.2 | 12.4 | 39.7 |
| 23 | 2.7 | 10.7 | 28.9 |
| 24 | 2.9 | 13.0 | 37.7 |
| 25 | 3.7 | 13.3 | 49.2 |
| 26 | 3.6 | 13.2 | 47.5 |
| 27 | 2.9 | 10.7 | 31.0 |
| 28 | 3.1 | 12.5 | 38.8 |
| 29 | 2.4 | 12.9 | 31.0 |
| 30 | 2.7 | 12.7 | 34.3 |
| 31 | 3.1 | 10.3 | 31.9 |
| 32 | 3.1 | 12.0 | 37.2 |
| 33 | 3.5 | 14.0 | 49.0 |

### EXAMPLES 34 to 63

### Impregnation of Populus sp

Samples of poplar tree (Populus sp) were prepared, impregnated and then irradiated according to the method described in examples 1 to 33. The weight ratios t₁ et t₂ as well as the MIC coefficient are reported in table 2 hereinafter.

The monomer used in example 34 is the epoxydated monoacrylate of example 1. The monomer used in example 35 is a trifunctional acrylated resin based on a glycerol derivative, commercialised by the company UCB (Drogenbos, Belgium) under the trade name OTA 480. The monomers used in examples 36 to 39 are polyfunctional acrylates defined hereinafter. In examples 40 to 43 mixtures comprising ⅔ (by weight) of a monoacrylate commercialised under the trade name Ebecryl 111 and ⅓ (by weight) of a polyfunctional acrylate defined hereinafter are used. In examples 44 to 46 mixtures comprising ⅓ (by weight) of the monomer Ebecryl 111 and ⅔ (by weight) of a polyfunctional acrylate defined hereinafter are used in examples 47 and 48 mixtures comprising ⅔ (by weight) of a monoacrylate commercialised under the trade name Ebecryl 112 and ⅓ (by weight) of a polyfunctional acrylate defined hereinafter are used. In examples 49 to 51 mixtures comprising ⅓ (by weight) of the monomer Ebecryl 112 and ⅔ (by weight) of a polyfunctional acrylate defined hereinafter are used. In examples 52 to 57 mixtures comprising ⅔ (by weight) of the monomer of example 1 and ⅓ (by weight) of an acrylate defined hereinafter are used. In examples 58 to 63 mixtures comprising ⅓ (by weight) of the monomer of example 1 and ⅔ (by weight) of an acrylate defined hereinafter are used.

The polyfunctional acrylate used in examples 40, 44, 47, 49, 53 and 59 is a tetrafunctional acrylate commercialised under the trade name Ebecryl 80.

The polyfunctional acrylate used in examples 42, 46, 51 and 62 is a tetrafunctional acrylate commercialised under the trade name Ebecryl 40.

The acrylate used in examples 41, 45, 48, 50, 55 and 61 is an ethoxylated trimethylolpropane triacrylate commercialised under the trade name Ebecryl 160.

The polyfunctional acrylate used in examples 43 and 56 is trimethylol-propane triacrylate. The polyfunctional acrylate used in examples 52 and 58 is tripropylene glycol diacrylate. The polyfunctional acrylate used in examples 57 and 63 is dipropylene glycol diacrylate.

The acrylate used in example 54 is the monomer Ebecryl 111. The acrylate used in example 60 is the monomer Ebecryl 112.

TABLE 2

| Example | t₁ | t₂ | MIC |
|---|---|---|---|
| 34 | 3.0 | 18.0 | 54.0 |
| 35 | 4.5 | 11.6 | 52.2 |
| 36 | 5.0 | 10.4 | 52.0 |
| 37 | 4.1 | 9.5 | 39.0 |
| 38 | 4.8 | 10.8 | 51.8 |
| 39 | 4.3 | 12.8 | 55.0 |
| 40 | 2.5 | 14.9 | 37.2 |
| 41 | 2.2 | 13.6 | 29.9 |
| 42 | 2.0 | 12.9 | 25.8 |
| 43 | 3.6 | 14.7 | 52.9 |
| 44 | 2.1 | 11.7 | 24.6 |
| 45 | 4.0 | 13.6 | 54.4 |
| 46 | 3.0 | 12.9 | 38.7 |
| 47 | 2.8 | 11.2 | 31.4 |
| 48 | 3.6 | 12.0 | 43.2 |
| 49 | 3.9 | 10.7 | 41.7 |
| 50 | 3.2 | 11.7 | 37.4 |
| 51 | 3.7 | 11.7 | 43.3 |
| 52 | 2.8 | 15.0 | 42.0 |
| 53 | 3.2 | 14.6 | 25.7 |
| 54 | 2.3 | 17.3 | 31.0 |
| 55 | 3.2 | 12.1 | 39.7 |
| 56 | 2.7 | 12.0 | 28.9 |
| 57 | 3.3 | 15.1 | 37.7 |
| 58 | 3.0 | 15.6 | 46.8 |
| 59 | 3.9 | 13.6 | 53.0 |
| 60 | 2.0 | 14.1 | 28.2 |
| 61 | 2.7 | 11.4 | 30.8 |
| 62 | 3.0 | 11.7 | 35.1 |
| 63 | 3.7 | 13.3 | 49.2 |

### EXAMPLES 64 to 71

### Double Impregnation of Pinus sylvestris

Samples of scots pine are prepared, impregnated then irradiated a first time according to the method described in the previous examples. After the first irradiation, they are again impregnated with a monomer or mixture of monomers, then irradiated under the same conditions as those used for the first treatment and already described. For the first impregnation, a monomer or mixture of monomers already used in one of examples 1 to 33 is used and written as such in table 3 hereinafter. For the second impregnation, a monomer or mixture of monomers already used in one of examples 1 to 63 is used and written as such in table 3 hereinafter. The weight ratios t₁ (relating to the sum of the monomers impregnated during the first and second impregnations) and t₂ as well as the MIC coefficient are reported in table 3 hereinafter.

TABLE 3

| Example | 1st impreg | 2^{nd} impreg. | t₁ | t₂ | MIC |
|---|---|---|---|---|---|
| 64 | Ex. 1 | Ex. 1 | 4.0 | 10.8 | 43.2 |
| 65 | Ex. 1 | Ex. 36 | 3.7 | 9.6 | 35.5 |
| 66 | Ex. 1 | Ex. 38 | 3.9 | 9.8 | 38.2 |
| 67 | Ex. 32 | Ex. 32 | 3.8 | 9.2 | 35.0 |
| 68 | Ex. 24 | Ex. 24 | 3.9 | 10.4 | 40.6 |
| 69 | Ex. 27 | Ex. 27 | 4.9 | 9.0 | 44.1 |
| 70 | Ex. 19 | Ex. 19 | 3.7 | 10.1 | 37.4 |
| 71 | Ex. 27 | Ex. 1 | 5.0 | 9.7 | 48.5 |

### EXAMPLES 72 to 79

### Double Impregnation of Populus sp

Samples of poplar tree are prepared, impregnated then irradiated twice under the conditions of examples 64 to 71. The monomers used for the first and second impregnation, as well as the weight ratios t₁ (relating to the sum of monomers impregnated) and t₂ as well as the MIC coefficient are reported in table 4 hereinafter.

TABLE 4

| Example | 1st impreg | 2^{nd} impreg. | t₁ | t₂ | MIC |
|---|---|---|---|---|---|
| 72 | Ex. 1 | Ex. 36 | 3.3 | 9.3 | 30.7 |
| 73 | Ex. 1 | Ex. 38 | 2.7 | 11.6 | 31.3 |
| 74 | Ex. 32 | Ex. 32 | 3.5 | 8.7 | 30.5 |
| 75 | Ex. 24 | Ex. 24 | 2.7 | 10.2 | 27.5 |
| 76 | Ex. 27 | Ex. 27 | 4.5 | 8.1 | 36.8 |
| 77 | Ex. 19 | Ex. 19 | 4.2 | 10.3 | 43.3 |
| 78 | Ex. 27 | Ex. 1 | 4.4 | 10.3 | 45.3 |
| 79 | Ex. 19 | Ex. 1 | 4.3 | 11.4 | 49.0 |

1-12. (cancelled).

13. A method for treating a piece of porous material based on cellulose and/or lignin comprising the steps of:
(a) impregnating the piece of porous material with at least one monomer comprising at least one vinyl group polymerisable by radiation, the impregnating monomer comprising a grafting monomer having at least one function capable of reacting with the hydroxyl groups of the cellulose and/or the lignin and/or at least one cross-linking monomer, then
(b) irradiating the piece of porous material impregnated in accordance with step (a) with high-energy ionising radiation,
(c) the method being characterised in that impregnation is carried out under conditions suitable for limiting the thickness of the impregnation layer to a thickness of about 0.1 to 5 mm beneath the surface of the piece of porous material and in that the amount of the impregnating monomer used in step (a) is comprised between about 1 and 9% by weight of the porous material impregnation layer.

14. A method for treating a porous material according to claim 13, characterised in that the impregnation is carried out essentially under atmospheric pressure.

15. A method for treating a porous material according to claim 13, characterised in that the impregnation is limited, beneath the surface of the piece of porous material, to a layer the thickness of which does not exceed about 30% of the smallest dimension of the piece.

16. A method for treating a porous material according to claim 13, characterised in that the impregnation is carried out essentially under atmospheric pressure and the impregnation is limited, beneath the surface of the piece of porous material, to a layer the thickness of which does not exceed about 30% of the smallest dimension of the piece.

17. A method for treating a porous material according to claim 13, characterised in that the impregnation is carried out essentially under atmospheric pressure and the impregnation is limited, beneath the surface of the piece of porous material, to a layer the thickness of which does not exceed about 20% of the smallest dimension of the piece.

18. A method for treating a porous material according to claim 13, characterised in that the impregnation is carried out essentially under atmospheric pressure and the impregnation is limited, beneath the surface of the piece of porous material, to a layer the thickness of which does not exceed about 10% of the smallest dimension of the piece.

19. A method for treating a porous material according to claim 13, characterised in that the amount of the impregnating monomer used in step (a) is comprised between about 2 and 6% by weight of the porous material impregnation layer.

20. A method for treating a porous material according to claim 13, characterised in that the impregnation conditions suitable for limiting the thickness of the impregnation layer include a temperature comprised between about 10° C. and 80° C. and/or a duration not exceeding about 90 minutes and/or a residual moisture ratio of the porous material not exceeding about 12% and/or a viscosity of the impregnating monomer at 25° C. comprised between about 10 et 3000 mPa.s.

21. A method for treating a porous material according to claim 13, characterised in that the impregnation conditions suitable for limiting the thickness of the impregnation layer include a temperature comprised between about 20° C. and 50° C.

22. A method for treating a porous material according to claim 13, characterised in that the impregnation conditions suitable for limiting the thickness of the impregnation layer include a residual moisture ratio of the porous material not below about 5% by weight.

23. A method for treating a porous material according to claim 13, characterised in that the porous material is wood.

24. A method for treating a porous material according to claim 13, characterised in that the high-energy ionising radiation is chosen among gamma radiation, electron beam and heavy ion beam.

25. A method for treating a porous material according to claim 13, characterised in that the irradiation energy of the high-energy ionising radiation used is comprised between about 20 kGy and 100 kGy.

26. A method for treating a porous material according to claim 13, characterised in that the energy used in the irradiation step (b) is comprised between about 1 MeV and 10 MeV.

27. A piece of porous material based on cellulose and/or lignin comprising, on a thickness of about 0.1 to 5 mm beneath its surface, a moisture impermeable film of a polymer grafted to said porous and/or crosslinked material such that the moisture impermeability coefficient of the material does not exceed 55, said coefficient being defined as the product of the weight rate (expressed in percentage) of moisture take-up of the material after having been dipped into water at 20° C. for 48 hours with the weight rate (expressed in percentage), relatively to the porous material, of the monomer(s) constituting the polymer of said moisture impermeable film.

28. A piece of porous material according to claim 27, characterised in that the porous material is wood.

29. A piece of porous material according to claim 27, characterised in that said polymer film derives from a grafting monomer having at least one function capable of reacting with the hydroxyl groups of cellulose and/or lignin and/or at least a cross-linking monomer.

30. A piece of porous material according to claim 27, characterised in that the weight ratio of moisture take-up of the material after having been dipped into water at 20° C. for 48 hours does not exceed 14% when the material based on cellulose and/or lignin is wood of the species Pinus sylvestris.

31. A piece of porous material according to claim 27, characterised in that the weight ratio of moisture take-up of the material after having been dipped into water at 20° C. for 48 hours do not exceed 18% when the material based on cellulose and/or lignin is wood of the species Populus sp.

32. A piece of porous material according to claim 27, characterised in that the thickness of the moisture impermeable film does not exceed about 30% of the smallest dimension of the piece of porous material.
